(19) United States
(12) Patent Application Publication
(10) Pub. No.: US 2014/0298318 A1
(43) Pub. Date: Oct. 2, 2014

(54) COMPUTER-EXECUTABLE APPLICATION PACKAGING METHOD, COMPUTER-EXECUTABLE DEVICE AND STORAGE MEDIA PERFORMING THE SAME

(71) Applicant: LG CNS CO., LTD., Seoul (KR)

(72) Inventors: Byung Hyun AHN, Seoul (KR); Seong-Man CHO, Seoul (KR); Myungho KIM, Seoul (KR); Hyejin KIM, Seoul (KR); Youra YANG, Seoul (KR); Na rae LEE, Seoul (KR); Sungjoon HAN, Seoul (KR)

(73) Assignee: LG CNS CO., LTD., Seoul (KR)

(21) Appl. No.: 14/221,772

(22) Filed: Mar. 21, 2014

(30) Foreign Application Priority Data
Mar. 29, 2013 (KR) 10-2013-0034223

(51) Int. Cl. G06F 9/445

(52) U.S. Cl. CPC G06F 8/60
USPC 717/174

(57) ABSTRACT

A method for generating a computer executable application package includes receiving a platform independent application package and searching, in a memory, a platform package template that corresponds to a target platform. The method further includes inserting the received platform independent application package into the searched platform package template to generate a pre-package, and repackaging the generated pre-package to generate a target platform dependent application package.

### CROSS-REFERENCE TO RELATED APPLICATIONS

Pursuant to 35 U.S.C. §119(a), this application claims the benefit of earlier filing date and right of priority to Korean Patent Application No. 10-2013-0034223, filed on Mar. 29, 2013, the contents of which are hereby incorporated by reference herein in their entirety.

### BACKGROUND OF THE INVENTION

1. Field of the Invention

The present invention relates to a computer executable application package generating method, a computer executable apparatus and more particularly to a computer executable application package generating method, a computer executable apparatus and a storage media generating various application packages without limitation of a mobile platform.

2. Background of the Invention

According to popularization of a smartphone, a plurality of developers join in a smartphone market to develop various mobile platforms. The mobile platform is referred to a mobile OS (Operating System) and corresponds to an operating system controlling a mobile device or an information device. The mobile platform is similar to a Windows operating system controlling a desktop computer or a laptop computer. However, the mobile platform focuses on processing broadband and a regional networking of a wireless version, a mobile media format and various input modes. A mobile platform being presently and commonly used is Symbian, Android, IOS, Blackberry OS, Windows mobile, Linux and Bada.

A conventional mobile platform application development may use a native development environment being provided to each of a plurality of mobile platforms to generate a corresponding platform dependent application. In order that a developer develops an application applying various mobile platforms, the developer may prepare a development tool by a target platform and may respectively use a skill being adaptable for the development environment to develop an application.

Korean Patent Publication No. 10-2012-0014389 (open to public on Feb. 17, 2012) relates to a smart phone application manufacturing solution being provided to improve the convenience of a programmer by automatically processing all processes related to compiling and creation of applications.

Korean Patent Publication No. 10-2012-0042291 (open to public on May 3, 2012) relates to a cross-platform solution and a cross-platform mobile source generating system being provided to enable an operating system to reduce inconvenience for developing a webpage of a mobile terminal by generating a cross-platform mobile source about a webpage.

Such prior art provides a hybrid mobile application development procedure that supports a mobile application development based on One Source Multi Use (OSMU). However, such prior art still have a problem that changes a work environment to a corresponding platform for generating a final package. That is, the hybrid mobile application development procedure may require high cost for an initial development environment construction due to preparing an exclusive development tool for an applied mobile platform not to solve the problem.

### SUMMARY

Embodiments of the present invention propose a computer executable application package generating method, a computer executable apparatus and a storage media repackaging an application package and package template to generate various application packages without limitation of a mobile platform.

Embodiments of the present invention propose a computer executable application package generating method, a computer executable apparatus and a storage media providing a package template including a platform specific basic application to apply all functions of a computer device.

Embodiments of the present invention proposes a computer executable application package generating method, a computer executable apparatus and a storage media reducing construction costs of a mobile application development environment through a unification of a package generation and distribution procedure.

Embodiments of the present invention proposes a computer executable application package generating method, a computer executable apparatus and a storage media easily using an application package managing an identical application with the application package excluding only a platform.

In some embodiments, a computer executable application package generating method includes receiving a platform independent application package, searching a platform package template corresponding to a target platform and inserting the application package in the searched platform package template to generate a pre-package and repackaging the generated pre-package to generate a target platform dependent application package.

In one embodiment, generating the pre-package may include receiving the platform package template to decompress the received platform package template and detecting an insertion point of the decompressed platform package template to determine whether the platform package template is combined with the application package.

In one embodiment, detecting the insertion point of the decompressed platform package template may include determining whether at least one insertion point of the decompressed platform package template is respectively combined with the application package.

In one embodiment, detecting the insertion point of the decompressed platform package template may further include respectively inserting the application package into the at least one insertion point when the combination is possible.

In one embodiment, determining whether the platform package template combines with the application package may include respectively matching codes in the application package with target platform dependent codes and replacing the matched code in the application package with a corresponding target platform dependent code.

In one embodiment, at least part of the application package may include a source code being implemented as a HTML5 and Java Script.

In one embodiment, the application package further may include an application resource including at least one of an image and a text.

In one embodiment, the platform package template may include a dependent code coupling a target platform specific library and operating a corresponding application on the target platform.

In one embodiment, the platform package template may be decompressed during a repackage procedure and may include at least one insertion point for the application package.

In one embodiment, the platform package template may further include at least one sub-package template being classified based on a usage field of the application package and an essential function required according to the usage field.

In one embodiment, generating the second application package dependent on the target platform may include compressing the pre-package as an executable format in the target platform.

In some embodiments, a computer executable apparatus includes an application package receiving unit configured to receive a platform independent application package, a pre-packaging unit configured to search a platform package template corresponding to a target platform and to insert the application package into the searched platform package template to generate a pre-package and an application package generating unit configured to repackage the generated pre-package to generate an second application package dependent on the target platform.

In one embodiment, the pre-packaging unit may receive the platform package template to decompress the received platform package template and may detect an insertion point of the decompressed platform package template to determine whether the platform package template is combined with the application package.

In one embodiment, the pre-packaging unit may determine whether at least one insertion point of the decompressed platform package template is respectively combined with the application package.

In one embodiment, the pre-packaging unit may respectively insert the application package into the at least one insertion point when the combination is possible.

In one embodiment, the pre-packaging unit may respectively match codes in the application package with target platform dependent codes and may replace the matched code in the application package with a corresponding target platform dependent code.

In one embodiment, at least part of the application package may include a source code being implemented as HTML5 and Java Script.

In one embodiment, the application package may further include an application resource including at least one of an image and a text.

In one embodiment, the platform package template may include a dependent code coupling a target platform specific library and operating a corresponding application on the target platform.

In one embodiment, the platform package template may be decompressed during a repackage procedure and may include at least one insertion point for the application package.

In one embodiment, the platform package template may further include at least one of a sub-package template being classified based on a usage field of the application package and an essential function required according to the usage field.

In one embodiment, the application package generating unit may compress the pre-package as an executable format in the target platform.

In some embodiments, a storage medium storing instructions that, when executed by a computer, cause the computer to perform a computer executable application package generating method, the method includes receiving a platform independent application package, searching a platform package template corresponding to a target platform and inserting the application package into the searched platform package template to generate a pre-package and repackaging the generated pre-package to generate a target platform dependent application package.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Embodiments of the present invention may repackage an application package and package template to generate various application package without limitation of a mobile platform.

Embodiments of the present invention may provide a package template including a platform specific basic application to apply all functions of a computer device.

Embodiments of the present invention may reduce a construction cost of a mobile application development environment through a unification of a package generation and distribution procedure.

Embodiments of the present invention may easily use an application package managing an identical application with the application package excluding only platform.

### BRIEF DESCRIPTION OF THE DRAWINGS

FIG. 1 depicts a computer executable application package generating procedure.

FIG. 2 is a block diagram illustrating a computer executable apparatus.

FIG. 3 is a flow chart depicting a method for generating a computer executable application package.

FIG. 4 is a diagram illustrating a procedure for inserting an application package into a decompressed platform package template.

### DETAILED DESCRIPTION

Explanation of the present invention is merely an embodiment for structural or functional explanation, so the scope of the present invention should not be construed to be limited to the embodiments explained in the embodiment. That is, since the embodiments may be implemented in several forms without departing from the characteristics thereof, it should also be understood that the described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first” and “second,” etc., may be used to describe various components, such components must not be understood as being limited to the above terms. The above terms are used to distinguish one component from another. For example, a first component may be referred to as a second component without departing from the scope of rights of the present invention, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Meanwhile, other expressions describing relationships between components such as “between”, “immediately between” or “adjacent to” and “directly adjacent to” may be construed similarly.

Singular forms “a”, “an” and “the” in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Identification letters (e.g., a, b, c, etc.) in respective steps are used for the sake of explanation and do not described order of respective steps. The respective steps may be changed from a mentioned order unless specifically mentioned in context. Namely, respective steps may be performed in the same order as described, may be substantially simultaneously performed, or may be performed in reverse order.

In describing the elements of the present invention, terms such as first, second, A, B, (a), (b), etc., may be used. Such terms are used for merely discriminating the corresponding elements from other elements and the corresponding elements are not limited in their essence, sequence, or precedence by the terms.

The present invention may be implemented as machine-readable codes on a machine-readable medium. The machine-readable medium includes any type of recording device for storing machine-readable data. Examples of the machine-readable recording medium include a read-only memory (ROM), a random access memory (RAM), a compact disk-read only memory (CD-ROM), a magnetic tape, a floppy disk, and optical data storage. The medium may also be carrier waves (e.g., Internet transmission). The computer-readable recording medium may be distributed among networked machine systems which store and execute machine-readable codes in a de-centralized manner.

The terms used in the present application are merely used to describe particular embodiments, and are not intended to limit the present invention. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

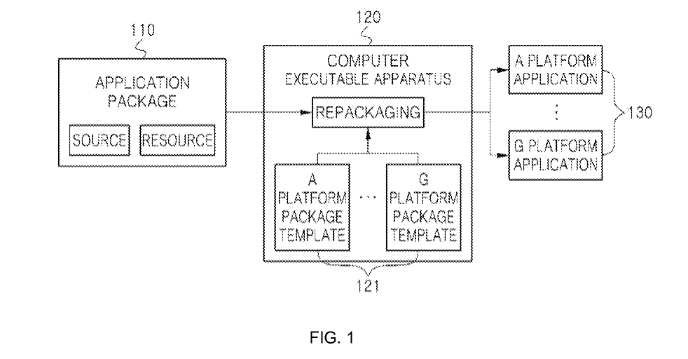

FIG. 1 depicts a computer executable application package generating procedure. In this figure, the computer executable apparatus 120 receives an application package 110 for adding to a platform package template 121 corresponding to a mobile platform selected by a user This generates a platform dependent application package 130 using a repackaging procedure. In one embodiment, the application package 110 may correspond to a hybrid application package. The hybrid application package corresponds to a source or resource group being generated in a development environment developing an application based on One Source Multi Use (OSMU).

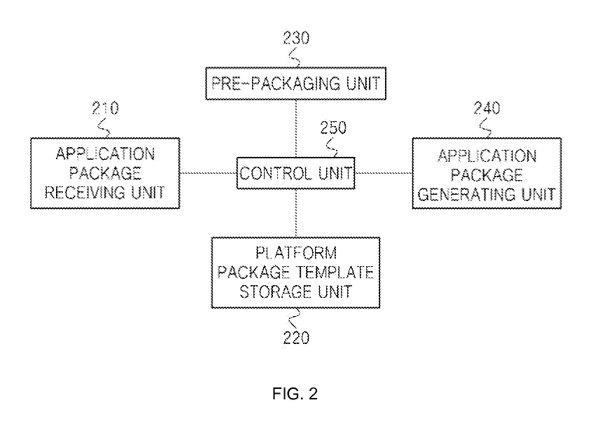

FIG. 2 is a block diagram illustrating a computer executable apparatus. In this figure, the computer executable apparatus 120 includes an application package receiving unit 210, a platform package template storage unit 220, a pre-packaging unit 230, an application package generating unit 240 and a control unit 250.

The computer executable apparatus 120 uses the application package 110 and the platform package template 121 to generate a platform dependent application package 130 (e.g., mobile platform dependent application package). For example, the computer executable apparatus 120 may correspond to a server, a desktop or a laptop.

The computer executable apparatus 120 may provide an application package generating program being implemented as a computer executable storage medium. The application package may be provided via, for example, computer program distribution and a computer program performance in a virtual or cloud computing environment.

The application package receiving unit 210 receives the application package 110. As an example, the application package 110 may correspond to a platform independent application package to be compatible with various platforms.

In one embodiment, at least part of the application package 110 may include source code being implemented as a HTML5 (Hyper Text Markup Language 5) and Java Script. It is known that HTML5 is a latest standard of a HTML which corresponds to a basic programming language for writing a web document and HTML5 may implement a same function without an installation of Active X and to create colorful graphic effects in a web browser without flash, Silverlight or Java FX. The source code may correspond to a blueprint representing software contents as a programming language.

If desired, the application package 110 may further include an application resource including at least one of an image, text, or binary file being interpreted through an external specific application or internal specific library. In addition, the application package receiving unit 210 may include a development environment supporting the hybrid application. The development environment provides a tool related to a build, packaging and runtime performing a mobile application source developed by a specific language on a specific mobile platform.

The platform package template storage unit 220 stores the platform package template 121 respectively corresponding to various mobile platforms and provides the platform package template 121 to the pre-packaging unit 230 according to control of the control unit 250.

The control unit 250 may select the corresponding platform package template 121 according to a generation requirement for a specific platform dependent application package received from a user or other device and may control the platform package template storage unit 220 to provide the corresponding platform package template 121 to the pre-packaging unit 230.

A template generally relates to a basic framework being frequently used for a certain diagram or formula. For example, in a spreadsheet, the template may be a specific table structure being formed for various data processing. As another example, the template may be a specific pattern of a predetermined image in order to be frequently used in a graphic program. As still another example, the template may be an item separately storing a command being frequently used for a program.

The platform package template storage unit 220 may store the platform package template 121 corresponding to a mobile platform. For example, the platform package template storage unit 220 may store an Android platform package template corresponding to the Android operating system, an IOS platform package template corresponding to the IOS operating system and a Windows platform package template corresponding to the Windows operating system.

The platform package template 121 may correspond to a basic application package form executable by a specific mobile platform and may be implemented as a minimum native language that the application is operated on the specific mobile platform.

In one embodiment, the platform package template 121 may include dependent code coupling a specific platform library and operating a corresponding application on the specific platform. Furthermore, the platform package template 121 may include a user interface for the specific platform.

The platform package template 121 may include a sub-package template being classified by an application usage field. In more detail, the platform package template 121 may include a sub-package template with an application usage field, and first and second functions to be classified. The usage field may be implemented as a field usable to an application like as a game, education, traffic, finance, multimedia and communication.

The first function refers to an essential function being required to the application by a usage field and the second function corresponds to a function departmentalizing the first function. For example, when an application A corresponds to education and relates to word processing, the first function essentially requires application A may respectively correspond to a word processing and spellchecking function and the second function for the word processing function may correspond to a table create and chart create function.

The sub-package template may correspond to the source or resource group being implemented as the native language in order to provide the second function. Thus the second function may be respectively classified according to the second function.

For example, the sub-package template may correspond to a document package template including a table create function of the word processing program, a game package template including a 3D activation function of a game program and a language package template including a microphone input and a sound source repetition play function of an education program.

This arrangement may minimize a problem that an application written with a common language does not control or apply to some functions of a corresponding device (e.g., a mobile terminal).

The platform package template 121 may be implemented as a ZIP format corresponding to an open standard for compressing or decompressing data. In one embodiment, the platform package template 121 may be decompressed in a repackaging procedure and may include at least one insertion point 410 for the application package.

The platform package template 121 may be implemented as a compressed format to permit storage, management and distribution in the corresponding device to be easier and may assign an access authority by a user to prevent changing of the platform package template 121. The platform package template 121 may be updated according to the version of the corresponding mobile platform.

The pre-packaging unit 230 generates a specific pre-package based on the application package and the specific platform package template 121. In more detail, when a specific platform is selected, the pre-packaging unit 230 may search the platform package template 121 corresponding to the specific selected platform, copy the searched platform package template 121 in a specific space of the pre-packaging unit 230 to decompress and insert the application package 110 in the decompressed platform package template 121 to generate the pre-package.

The pre-packaging unit 230 inserts the application package 110 in the platform package template 121 to generate the pre-package. The pre-package may be a primary product before completion of the repackaging procedure. For example, the application package generating unit 240 may insert a source and resource of the application package 110 in the decompressed platform package template to generate the pre-package.

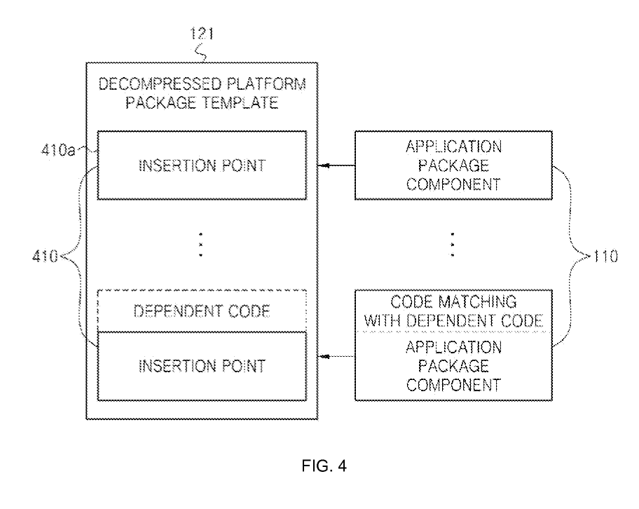

In one embodiment, the pre-packaging unit 230 may receive the platform package template 121 corresponding to the selected platform and decompress the template. The pre-packaging unit 230 may also detect the insertion point 410a (FIG. 4) to determine whether the application package 110 is combined with the insertion point 410a. The insertion point 410a may include a point defining an area that an additional function or feature is inserted or replaced in a basic application in the platform package template 121 or the area itself.

For example, the pre-packaging unit 230 may receive the Android platform package template 121 corresponding to an Android OS selected by user A from the platform package template storage unit 220. The pre-packaging unit 230 may also generate a source Z formed on a library X, interface Y and specific language used for the Android being included in the Android platform package template through decompression, and may determine whether a source S and a resource P included the application package 110 are combined.

In one embodiment, the pre-packaging unit 230 may determine whether the decompressed insertion point 410 of the specific platform package template 121 is respectively matched with the application package 110.

If desired, some or all of components 210, 230, and 240 may alternatively or additionally be performed by control unit 250.

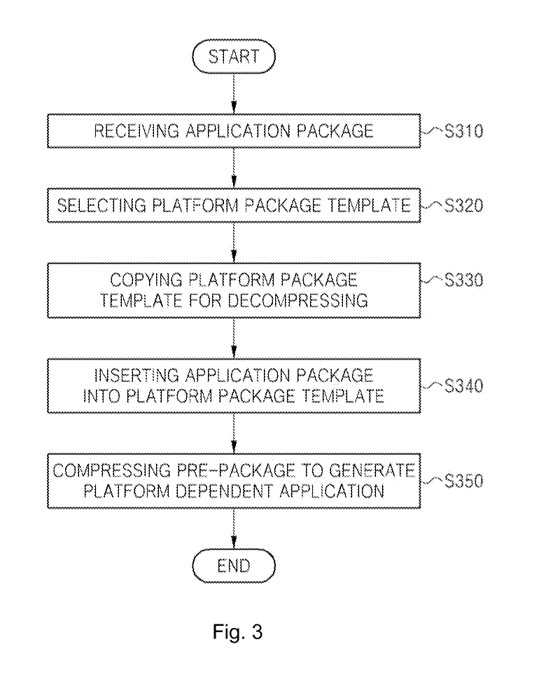

FIG. 3 is a flowchart depicting a method for generating a computer executable application package. In FIG. 3, block S310 indicates that the application package receiving unit 210 may receive the application package 110 and generate requirements for the platform dependent application package 130 selected by the user or other device. For example, the application package receiving unit 210 may receive the generation requirement for the application package 110 and the platform dependent application package 130 (e.g., Android or Windows platform dependent application package) from the user.

In one embodiment, the application package receiving unit 210 may further receive information for a usage field, and first and second functions. For example, the application package receiving unit 210 may receive the generation requirement for an application package including executable functions for the Android platform (e.g., a word processing function and a table and chart generation function) from the user in a utility field. The display unit may provide an input screen gradually receiving the information of the usage field and the first and second functions related to the generation requirement for the application package 110 from the user.

At block S320, the pre-packaging unit 230 may request selecting the platform package template 121 corresponding to the selected specific platform and cause the platform package template storage unit 220 to provide the application package template 121 to the application package generating unit.

In one embodiment, the pre-packaging unit 230 may consider the usage field, and the first and second functions of the application package 110 to determine the platform package template 121. The platform package template storage unit 220 may further include a package template list being classified according to the usage field and the first and second functions. The pre-packaging unit 230 may also determine at least one platform package template 121 suitable for the application package 110 based on the package template list.

At block S330, the pre-packaging unit 230 may copy the platform package template 121 to a specific space to decompressing. For example, the pre-packaging unit 230 may copy the platform package template 121 to a Work Directory folder for the decompressing.

At block S340, the application package generating unit 240 may insert the application package 110 into the decompressed platform package template 121 to generate a pre-package. For example, the repackaging unit 140 may insert a hybrid application source and resource in the decompressed platform package template 121. The insertion procedure corresponds to adding the hybrid application source and resource in the decompressed platform package template 121 to generate the pre-package.

In one embodiment, inserting the application package 110 into the decompressed platform package template 121 may include detecting at least one insertion point 410 of the decompressed platform package template 121 to determine whether the at least one insertion point is combined with the application package 110. The platform package template may also determine whether the at least one insertion point 410 respectively matches with the application package 110 and respectively inserting the application package 110 in the matched at least one insertion point 410 when there is a match.

When a part of the application package 110 overlaps with the at least one insertion point 410, this overlapping part corresponds to a platform dependent code. Inserting the application package 110 in the matched at least one insertion point 410 may include matching the codes in the application package 110 with the platform dependent codes in order to replace the application package 110 in the dependent code and replacing the codes in the application package 110 in the platform dependent code when the matching is completed.

Block S350 provides for the application package generating unit 240 performing a repackaging by recompressing the pre-package to generate the platform dependent application package 130 selected by the user.

The application package generating unit 240 may provide the platform dependent application package 130 generated through the repackaging to the user or other device.

In one embodiment, when the computer executable apparatus 120 receives the generation requirement for the platform dependent application package 130 corresponding to a plurality of platforms from the user or other device, the application package generating unit 240 may gradually or incrementally generate a platform dependent application package 130 (e.g., first platform, second platform and third platform). Otherwise, the computer executable apparatus 120 may simultaneously generate the platform dependent application package (e.g., the plurality of platforms) through multi-tasking.

FIG. 4 is a diagram illustrating a procedure for inserting an application package into a decompressed platform package template. Referring FIG. 4, the decompressed platform package template 121 includes the at least one insertion point 410. The application package 110 may include at least one code, source, or resource. The at least one insertion point 410 may correspond to an area for inserting a code including a specific function. For example, the specific function may correspond to a video play function or an image display function.

The pre-packaging unit 230 may consider the insertion point 410a and a feature, a function, or an implemented form for each of composition of the application package 110 to determine whether the application package is matched with the insertion point 410a. For example, when an insertion point X and Y, source A and resource B of a hybrid application exist, the pre-packaging unit 230 may match the insertion point X and the resource B.

In one embodiment, when the insertion point 410a of the decompressed specific platform package template 121 is respectively matched with the application package 110, the pre-packaging unit 230 may respectively insert the application package 110 into the matched insertion point 410a. For example, when an insertion point X is matched with a hybrid application source A and an insertion point Y is matched with a resource B, the pre-packaging unit 230 may sequentially insert the source A and resource B into the insertion point X, Y.

In one embodiment, the pre-packaging unit 230 matches codes in the application package 110 with dependent codes of the corresponding platform. When the matching is complete, the pre-packaging unit 230 may replace the codes in the application package 110 as the platform dependent code. The platform dependent code may correspond to an essentially required code in order to perform the application on the corresponding platform. For example, when the platform corresponds to the Android platform, the platform dependent code may correspond to AndroidManifest.xml file.

As another example, when the hybrid application source Y is matched with the insertion point X in the platform package template 121 and the source Y is required to be a larger area than the insertion point X, the pre-packaging unit 230 may determine whether a code B of the platform corresponds to the dependent code. The code B is matched the code A of the source Y exceeding the insertion point X. When the code A is matched with the dependent code, the pre-packaging unit 230 may replace the code A in the code B or delete the code A. That is, when the source code A and the dependent code B matches as to performing a same function, the pre-packaging unit 230 may replace part of the source code with the dependent code B and delete the code A.

The application package generating unit 240 performs a repackaging for the pre-package to generate the platform dependent application package 130. In one embodiment, the application generating unit 240 may perform a repackaging which compresses the pre-package as a executable format in the corresponding platform to generate the platform dependent application package 130. For example, the application generating unit 240 may perform compressing the pre-package generated based on the platform package template (e.g., Android platform package template) to generate an Android application package being implemented as the executable format in the Android platform such as a XXX.apk.

The application package generating unit 240 may also provide the platform dependent application package 130 generated through the repackaging to a user or other device. The application package generating unit 240 may include a communication module for transmitting data. One option includes the application generating unit 240 having an application storage space for temporarily storing the generated platform dependent application package 130. Meanwhile, the pre-packaging unit 230 and the application package generating unit 240 may be implemented as a repackaging unit including each of composition thereof.

The control unit 250 controls operation and flow of the application package receiving unit 210, the platform package template storage unit 220 and the application package generating unit 240. The control unit 250 may select the corresponding platform package template 121 according to the generation requirement for a specific platform dependent application package received from a user or other device and may control the platform package template storage unit 220 to provide the corresponding platform package template 121 to the pre-packaging unit 230.

The computer executable apparatus 120 may further include an input unit receiving an input for an application execution requirement or writing the application package 110 from the user and a display unit outputting an application package generation procedure or execution screen.

Although this document provides descriptions of preferred embodiments of the present invention, it would be understood by those skilled in the art that the present invention can be modified or changed in various ways without departing from the technical principles and scope defined by the appended claims.

### Description of Symbols

110: APPLICATION PACKAGE

120: COMPUTER EXECUTABLE APPARATUS

121: PLATFORM PACKAGE TEMPLATE

130: PLATFORM DEPENDENT APPLICATION PACKAGE

210: APPLICATION PACKAGE RECEIVING UNIT

220: PLATFORM PACKAGE TEMPLATE STORAGE UNIT

230: PRE-PACKAGING UNIT

240: APPLICATION PACKAGE GENERATING UNIT

250: CONTROL UNIT

410: AT LEAST ONE INSERTION POINT

410a: INSERTION POINT

What is claimed is:

1. A method for generating a computer executable application package, the method comprising:
receiving a platform independent application package;
searching, in a memory, a platform package template that corresponds to a target platform;
inserting the received platform independent application package into the searched platform package template to generate a pre-package; and
repackaging the generated pre-package to generate a target platform dependent application package.

2. The method of claim 1, wherein the generating the pre-package includes:
receiving the platform package template;
decompressing the received platform package template; and
detecting an insertion point of the decompressed platform package template to determine whether the platform package template is combined with the platform independent application package.

3. The method of claim 2, wherein the detecting the insertion point of the decompressed platform package template includes determining whether at least one insertion point of the decompressed platform package template is respectively combined with the platform independent application package.

4. The method of claim 3, wherein the detecting the insertion point of the decompressed platform package template further includes inserting the platform independent application package into each of the at least one insertion point when combination of the decompressed platform package template with the platform independent application package is possible.

5. The method of claim 2, wherein the determining whether the platform package template is combined with the platform independent application package includes:
respectively matching codes in the platform independent application package with target platform dependent codes; and
replacing the matched codes in the platform independent application package with corresponding target platform dependent codes.

6. The method of claim 1, wherein at least part of the platform independent application package includes a source code being implemented as a HTML5 and Java Script.

7. The method of claim 6, wherein the platform independent application package further includes an application resource including at least one of an image or text.

8. The method of claim 1, wherein the platform independent platform package template includes a dependent code coupling a target platform specific library and operating a corresponding application on the target platform.

9. The method of claim 8, wherein the independent platform package template is decompressed during a repackage procedure and includes at least one insertion point for the independent platform application package.

10. The method of claim 8, wherein the independent platform package template further includes at least one sub-package template that is classified based on a usage field of the independent platform application package and an essential function required according to the usage field.

11. The method of claim 1, wherein the generating the target platform dependent application package includes compressing the pre-package as an executable format in the target platform.

12. An apparatus, comprising:
a memory; and
a controller operatively coupled to the memory and configured to:
receive a platform independent application package;
search, in the memory, a platform package template that corresponds to a target platform;
insert the received platform independent application package into the searched platform package template to generate a pre-package; and
repackage the generated pre-package to generate a target platform dependent application package.

13. The apparatus of claim 12, wherein the controller is further configured to generate the pre-package by:
receiving the platform package template;
decompressing the received platform package template; and
detecting an insertion point of the decompressed platform package template to determine whether the platform package template is combined with the platform independent application package.

14. The apparatus of claim 13, wherein the detecting the insertion point of the decompressed platform package template includes determining whether at least one insertion point of the decompressed platform package template is respectively combined with the platform independent application package.

15. The apparatus of claim 14, wherein the detecting the insertion point of the decompressed platform package template further includes inserting the platform independent application package into each of the at least one insertion point when combination of the decompressed platform package template with the platform independent application package is possible.

16. The apparatus of claim 13, wherein the controller is further configured to perform the determining whether the platform package template is combined with the platform independent application package by:
respectively matching codes in the platform independent application package with target platform dependent codes; and
replacing the matched codes in the platform independent application package with corresponding target platform dependent codes.

17. The apparatus of claim 12, wherein at least part of the platform independent application package includes a source code being implemented as a HTML5 and Java Script.

18. The apparatus of claim 17, wherein the platform independent application package further includes an application resource including at least one of an image or text.

19. The apparatus of claim 12, wherein the platform independent platform package template includes a dependent code coupling a target platform specific library and operating a corresponding application on the target platform.

20. The apparatus of claim 19, wherein the independent platform package template is decompressed during a repackage procedure and includes at least one insertion point for the independent platform application package.

21. The apparatus of claim 19, wherein the independent platform package template further includes at least one sub-package template that is classified based on a usage field of the independent platform application package and an essential function required according to the usage field.

22. The apparatus of claim 12, wherein the generating the target platform dependent application package includes compressing the pre-package as an executable format in the target platform.

23. A non-transitory machine-readable medium comprising code, which, when executed by a machine, causes the machine to perform operations, the operations comprising:
receiving a platform independent application package;
searching, in a memory, a platform package template that corresponds to a target platform;
inserting the received platform independent application package into the searched platform package template to generate a pre-package; and
repackaging the generated pre-package to generate a target platform dependent application package.
